(19) United States
(12) Patent Application Publication
(10) Pub. No.: US 2025/0302109 A1
(43) Pub. Date: Oct. 2, 2025

(54) ATOMIZATION CORE, ATOMIZER, AND ELECTRONIC ATOMIZATION APPARATUS

(71) Applicant: SHENZHEN FIRST UNION TECHNOLOGY CO., LTD., Shenzhen, Guangdong (CN)

(72) Inventors: Rui HONG, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/881,502

(22) PCT Filed: Jun. 30, 2023
(86) PCT No.: PCT/CN2023/105056

§ 371 Date: Jan. 6, 2025

(30) Foreign Application Priority Data
Jul. 6, 2022 (CN) 202221762480.1

(51) Int. Cl. A24F 40/465; A24F 40/10; A24F 40/44; A24F 40/48; H05B 6/10

(52) U.S. Cl. CPC A24F 40/465; A24F 40/10; A24F 40/44; A24F 40/48; H05B 6/105

(57) ABSTRACT

An atomization core, an atomizer, and an electronic atomization apparatus are provided. The atomization core includes: a liquid transfer unit in a shape of a tube with a hollow interior, an outer surface of the liquid transfer unit being configured to absorb a liquid substrate; a susceptor to be penetrated by a variable magnetic field to generate heat, so as to heat the liquid substrate absorbed by the liquid transfer unit to generate an aerosol, the susceptor being in the shape of a sheet or a plate. The susceptor is arranged within the liquid transfer unit, and at least part of a surface of the susceptor is in contact with the liquid transfer unit. In the atomization core, the sheet-like or plate-like susceptor is arranged in the hollow interior of the tubular liquid transfer unit.

### CROSS-REFERENCE TO RELATED APPLICATIONS

This application claims priority to Chinese Patent Application No. 202221762480.1, filed with China National Intellectual Property Administration on Jul. 6, 2022 and entitled “ATOMIZATION CORE, ATOMIZER, AND ELECTRONIC ATOMIZATION APPARATUS”, which is incorporated herein by reference in its entirety.

### TECHNICAL FIELD

This application relates to the field of electronic atomization technologies, and in particular, to an atomization core, an atomizer, and an electronic atomization apparatus.

### BACKGROUND

An electronic atomization apparatus is an electronic product that generates an aerosol by atomizing a liquid substrate for a user to inhale, which generally includes two parts: an atomizer and a power supply assembly. The atomizer has the liquid substrate stored therein and is provided with an atomization core for atomizing the liquid substrate. The power supply assembly includes a battery and a circuit board.

An existing atomization core is usually a ceramic core structure integrally formed by a heating wire and a porous ceramic. The heating wire is powered by the power supply assembly to generate heat to generate a high temperature to heat and atomize the liquid substrate. The atomization core has problems of a complicated structural design and low heating efficiency.

### SUMMARY

This application provides an atomization core, an atomizer, and an electronic atomization apparatus, so as to resolve problems of a complicated structural design and low heating efficiency of an existing atomization core.

An aspect of this application provides an atomization core, including:
a liquid transfer unit, constructed in a shape of a tube with a hollow interior, where an outer surface of the liquid transfer unit is configured to absorb a liquid substrate; and
a susceptor, configured to be penetrated by a variable magnetic field to generate heat, so as to heat the liquid substrate absorbed by the liquid transfer unit to generate an aerosol, where the susceptor is constructed to be shaped like a plate or a sheet; and
the susceptor is arranged within the liquid transfer unit, and at least part of a surface of the susceptor is in contact with the liquid transfer unit.

Another aspect of this application provides an atomizer for an electronic atomization apparatus, including a liquid storage chamber for storing a liquid substrate and the atomization core.

Another aspect of this application further provides an electronic atomization apparatus, including a magnetic field generator configured to generate a variable magnetic field under an alternating current, and the atomization core.

In the atomization core, the sheet-like or plate-like susceptor is arranged in the hollow interior of the tubular liquid transfer unit, and the susceptor has features of rapid temperature increase and low power consumption, thereby improving heating efficiency of the atomization core.

### BRIEF DESCRIPTION OF THE DRAWINGS

One or more embodiments are exemplarily described with reference to the corresponding figures in the accompanying drawings, and the exemplary descriptions do not constitute a limitation on the embodiments. Elements in the accompanying drawings that have the same reference numeral are represented as similar elements, and unless otherwise particularly stated, the figures in the accompanying drawings are not drawn to scale.

FIG. 1 is a schematic diagram of an electronic atomization apparatus according to an implementation of this application.

FIG. 2 is a schematic exploded view of an electronic atomization apparatus according to an implementation of this application.

FIG. 3 is a schematic diagram of an atomizer according to an implementation of this application.

FIG. 4 is a schematic cross-sectional view of an atomizer according to an implementation of this application.

FIG. 5 is a schematic diagram of an upper support according to an implementation of this application.

FIG. 6 is a schematic exploded view of an atomization core according to an implementation of this application.

FIG. 7 is a schematic diagram of a bottom base according to an implementation of this application.

FIG. 8 is a schematic cross-sectional view of a bottom base according to an implementation of this application.

FIG. 9 is a schematic cross-sectional view of a power supply assembly according to an implementation of this application.

FIG. 10 is a schematic diagram of a lower shell according to an implementation of this application.

FIG. 11 is a schematic diagram of a lower support according to an implementation of this application.

FIG. 12 is a schematic diagram of a base according to an implementation of this application.

FIG. 13 is a schematic diagram of a magnetic field generator according to an implementation of this application.

FIG. 14 is a schematic cross-sectional view of a magnetic field generator according to an implementation of this application.

### DETAILED DESCRIPTION

For ease of understanding of this application, this application is described below in more detail with reference to the accompanying drawings and specific implementations. It should be noted that, when an element is described to be “fixed to” another element, the element may be directly fixed to the another element, or there may be one or more intermediate elements therebetween. When one element is described to be “connected to” another element, the element may be directly connected to the another element, or there may be one or more intermediate elements therebetween. Terms “upper”, “lower”, “left”, “right”, “inner”, “outer”, and similar expressions used in this specification are for illustrative purposes only.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. A term “and/or” used in this specification includes any or all combinations of one or more related listed items.

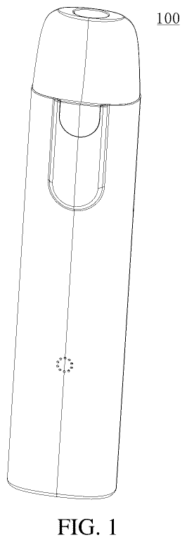

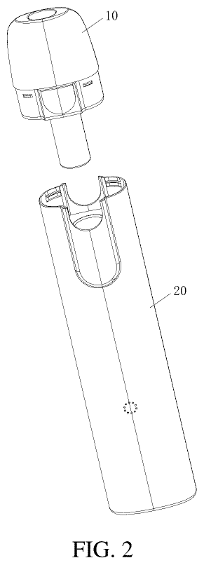

As shown in FIG. 1 and FIG. 2, an electronic atomization apparatus 100 includes an atomizer 10 and a power supply assembly 20.

The atomizer 10 is detachably or removably connected to the power supply assembly 20, including but not limited to a snap fit, a magnetic connection, and a threaded connection.

In a preferred implementation, an outer surface of the atomizer 10 is provided with a bump. An inner surface of the power supply assembly 20 is provided with a groove. The snap fit of the atomizer 10 and the power supply assembly 20 is implemented through engagement of the bump and the groove.

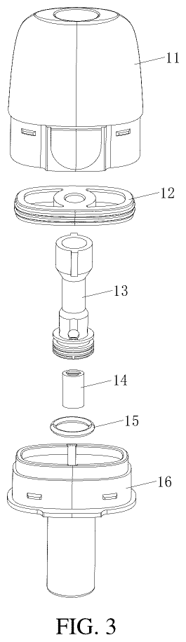

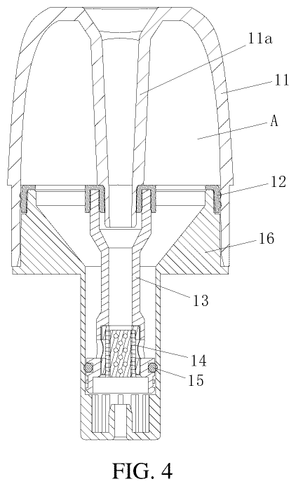

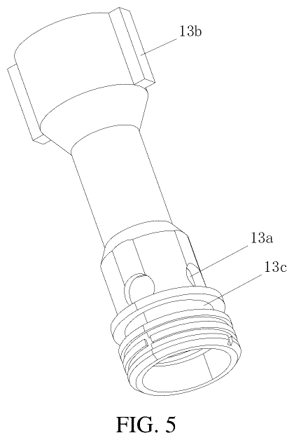

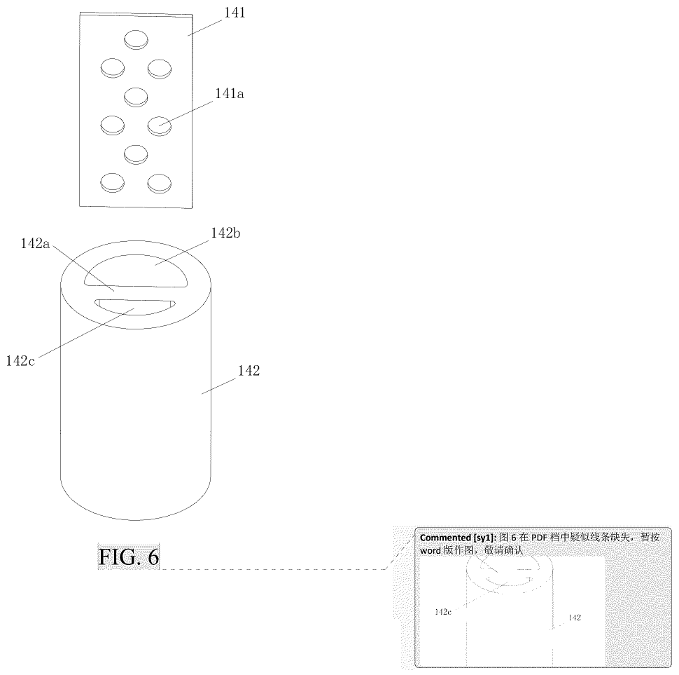

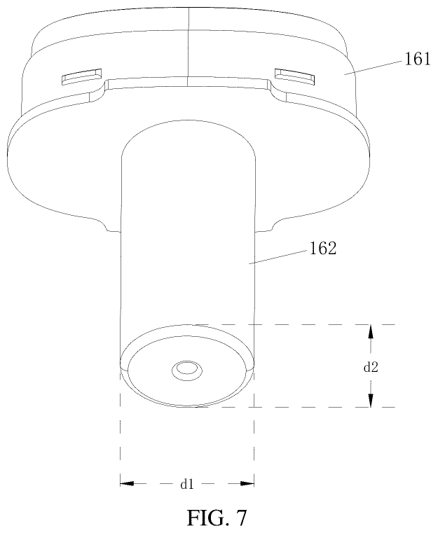

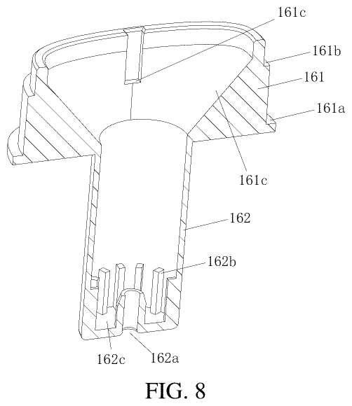

As shown in FIG. 3 to FIG. 8, the atomizer 10 includes an upper shell 11, a seal member 12, an upper support 13, an atomization core 14, a seal member 15, and a bottom base 16.

The upper shell 11 has a suction nozzle end and an open end. An air outlet is provided on the suction nozzle end, and an atomized aerosol may be inhaled by a user through the air outlet. An integrally formed transmission tube 11a is further arranged in the upper shell 11. An inner surface of the transmission tube 11a defines a part of an airflow channel. An upper end of the transmission tube 11a is in communication with the air outlet, and a lower end thereof is connected to the upper support 13. In another example, it is also feasible that the transmission tube 11a is formed by a single hollow tube.

A liquid storage chamber A is jointly defined or formed by an inner surface of the upper shell 11 and an inner surface of the bottom base 16. The liquid storage chamber A is configured to store a liquid substrate that may generate an aerosol.

The liquid substrate preferably includes a tobacco-containing material. The tobacco-containing material includes a volatile tobacco aroma compound released from the liquid substrate when being heated. Alternatively or additionally, the liquid substrate may include a non-tobacco material. The liquid substrate may include water, ethanol or another solvent, a plant extract, a nicotine solution, and natural or artificial flavoring agents. Preferably, the liquid substrate further includes an aerosol-forming agent. Examples of a suitable aerosol-forming agent are glycerol and propylene glycol.

The seal member 12 is arranged between the transmission tube 11a and the upper support 13 and between the bottom base 16 and the upper shell 11, to seal a gap between the transmission tube 11a and the upper support 13 and a gap between the bottom base 16 and the upper shell 11. In another example, the seal member 12 may include a plurality of separate seal members. For example, one seal member is arranged between the transmission tube 11a and the upper support 13, and another seal member is arranged between the bottom base 16 and the upper shell 11. In another example, it is also feasible that the seal member 12 and the bottom base 16 (or the upper shell 11) are integrally formed, for example, integrally formed through two-shot injection molding. In another example, it is also feasible that the seal member 12 is not arranged.

In a further implementation, an air pressure balance channel may be arranged in the seal member 12, and/or between the seal member 12 and the transmission tube 11a, and/or between the seal member 12 and the upper shell 11, and/or between the transmission tube 11a and the upper support 13, and/or between the bottom base 16 and the upper shell 11, to supplement the liquid storage chamber A with a gas to balance air pressures within and outside the liquid storage chamber A, which facilitates transfer of the liquid substrate.

The upper support 13 is substantially in a shape of a tube. An upper end of the upper support 13 extends toward a first portion 161 and is connected to the transmission tube 11a. A lower end of the upper support 13 is accommodated in a second portion 162 of the bottom base 16. An inner hollow portion of the upper support 13 defines part of the airflow channel. An inner diameter or an outer diameter of a middle portion of the upper support 13 is less than an inner diameter or an outer diameter of another portion.

In a further implementation, a positioning portion 13b extending radially outward is arranged on an outer surface of the upper support 13 close to an upper end, and a groove 161c is provided in the first portion 161 of the bottom base 16. During assembly, the positioning portion 13b needs to be aligned with the groove 161c, so that the positioning portion 13b is at least partially fitted into the groove 161c, thereby fixing or holding the upper end of the upper support 13.

In a further implementation, a support portion 162b is arranged in the second portion 162 of the bottom base 16, and an end portion of the lower end of the upper support 13 abuts against the support portion 162b. In a preferred implementation, the support portion 162b includes a plurality of bumps arranged at intervals. The plurality of bumps arranged at intervals protrude from an inner side wall or a bottom wall of the second portion 162. In this way, the liquid substrate or a condensed liquid substrate may flow into a collecting cavity 162c along a gap between the bumps.

In a further implementation, an accommodating groove 13c is provided on the outer surface of the upper support 13 close to the lower end. At least part of the seal member 15 is accommodated in the accommodating groove 13c. The seal member 15 is configured to seal a gap between the upper support 13 and the second portion 162.

In another example, it is also feasible that the upper support 13 and the transmission tube 11a are integrally formed.

The atomization core 14 is accommodated in the upper support 13 and is arranged close to the lower end of the upper support 13. In a further implementation, a seal member may be arranged between the atomization core 14 and the upper support 13 to form a seal, such as silicone. After the assembly, the atomization core 14 is completely located in the second portion 162 of the bottom base 16. A liquid passing hole 13a is provided on a side wall of the upper support 13. The liquid substrate stored in the liquid storage chamber A is transmitted to the atomization core 14 through the liquid passing hole 13a.

The atomization core 14 includes a susceptor 141. The susceptor 141 is configured to be inductively coupled to a magnetic field generator 26, and be penetrated by a variable magnetic field to generate heat, thereby heating the liquid substrate to generate an aerosol for inhalation. The susceptor 141 may be made of at least one of the following materials: aluminum, iron, nickel, copper, bronze, cobalt, ordinary carbon steel, stainless steel, ferritic stainless steel, martensitic stainless steel, or austenitic stainless steel.

In a further implementation, the atomization core 14 may further include a liquid transfer unit 142, to absorb the liquid substrate passing through the liquid passing hole 13a and transfer the absorbed liquid substrate to the susceptor 141. The liquid transfer unit 142 may be made of, for example, a cotton fiber, a metal fiber, a ceramic fiber, a glass fiber, porous ceramics, or the like. In another implementation, the susceptor 141 may integrate functions of liquid guiding and atomization. It is also feasible that the liquid transfer unit 142 is not arranged. The liquid transfer unit 142 may be in a shape of a bar or a tube or a rod, and may be further in a shape of a plate, a sheet, or a concave block having a cavity on a surface thereof, or in a shape of an arch of an arch structure, or the like.

In a preferred implementation, the liquid transfer unit 142 uses the porous ceramics. A material of the porous ceramics includes at least one of alumina, zirconia, kaolin, diatomite, and montmorillonite. A porosity of the porous ceramics may be adjusted within a range of 10% to 90%, and an average pore size may be adjusted within a range of 10 μm to 150 μm. In some implementations, the adjustment may be performed, for example, by selecting an additive amount of a pore-forming agent and a particle size of the pore-forming agent.

In the preferred implementation, the liquid transfer unit 142 is constructed in a shape of a tube with a hollow interior. The shape of the tube may be a shape of a circular tube or a shape of a square tube. Preferably, the shape of the circular tube is adopted. The liquid transfer unit 142 further includes a spacer 142a. The spacer 142a is longitudinally arranged to extend. A wall thickness (a thickness size) of the spacer 142a is in a range of 0.1 mm to 1 mm, preferably in a range of 0.2 mm to 1 mm, preferably in a range of 0.4 mm to 1 mm, preferably in a range of 0.4 mm to 0.8 mm, and preferably in a range of 0.4 mm to 0.6 mm. In a specific example, the wall thickness of the spacer 142a is 0.5 mm.

A longitudinal extension length (a longitudinal size) of the spacer 142a is the same as that of the liquid transfer unit 142. The spacer 142a divides the hollow interior of the liquid transfer unit 142 into a first chamber 142b and a second chamber 142c, which helps maintain strength of the liquid transfer unit 142, reduce a volume of the liquid transfer unit 142, and improve heating efficiency of the atomization core 14. The first chamber 142b and the second chamber 142c extend longitudinally between substantially flat opposite end surfaces. A cross-sectional area of the first chamber 142b is greater than a cross-sectional area of the second chamber 142c. The cross-section of the first chamber 142b is semicircular.

The susceptor 141 is in a shape of a sheet or a plate. A longitudinal extension direction of the susceptor 141 is parallel to or coincides with a central axis of the liquid transfer unit 142. A longitudinal size of the susceptor 141 is greater than a transverse size of the susceptor 141. The susceptor 141 is arranged within the liquid transfer unit 142, and at least part of a surface of the susceptor 141 is in contact with the liquid transfer unit 142. Specifically, the susceptor 141 is arranged within the first chamber 142b, and the susceptor 141 is maintained in contact with a side wall of the spacer 142a or part of the susceptor 141 is buried in the spacer 142a (an other part of the susceptor 141 is exposed outside the spacer 142a). The susceptor 141 is held on the side wall of the spacer 142a, and a thickness size of the susceptor 141 is less than a thickness size of the spacer 142a. The transverse size of the susceptor 141 is the same as a diameter (that is, an inner diameter of the liquid transfer unit 142) of the first chamber 142b having a semicircular cross-section. Generally, the transverse size thereof is in a range of 1 mm to 4 mm, preferably in a range of 1 mm to 3 mm, preferably in a range of 1 mm to 2.5 mm, preferably in a range of 1.5 mm to 2.5 mm, and preferably in a range of 2 mm to 2.5 mm. The longitudinal size of the susceptor 141 is the same as a longitudinal size of the liquid transfer unit 142. Generally, the longitudinal size thereof is in a range of 4 mm to 8 mm, preferably in a range of 4 mm to 7 mm, and preferably in a range of 4 mm to 6 mm. A thickness of the susceptor 141 may be as small as possible. Generally, the thickness thereof is in a range of 0.05 mm to 0.5 mm, preferably in a range of 0.05 mm to 0.2 mm, preferably in a range of 0.05 mm to 0.15 mm, and preferably in a range of 0.08 mm to 0.15 mm. The susceptor 141 has a plurality of through holes 141a arranged at intervals along a thickness direction, with a pore size in a range of 0.1 mm to 0.5 mm, and a shape of each of the through holes may be a circle, an ellipse, a triangle, a rhombus, or another regular or irregular shape. In this way, a volume of the susceptor 141 is reduced, an atomization area of the susceptor 141 can be maximized, and the heating efficiency of the atomization core 14 can be further improved.

The side wall of the spacer 142a in contact with the susceptor 141 defines or forms an atomization surface of the atomization core 14. An outer side wall or an outer surface of the liquid transfer unit 142 defines or forms a liquid absorption surface that absorbs the liquid substrate. In this way, the absorbed liquid substrate is heated to generate the aerosol when being transferred to the susceptor 141, and the generated aerosol flows into the first chamber 142b and flows out from the first chamber 142b together with air flowing in from a bottom of the first chamber 142b. Through the spacer 142a, the liquid transfer unit 142 may transfer the liquid substrate to the susceptor 141 in time to avoid a phenomenon of dry heating of the susceptor 141. Since heat of the susceptor 141 may be transferred to an other side wall of the spacer 142a, the liquid substrate of the other side wall may also be heated to generate an aerosol. The generated aerosol flows into the second chamber 142c and out of the second chamber 142c together with air flowing in from a bottom of the second chamber 142c. In this way, the hollow interior of the liquid transfer unit 142 forms an airflow channel, so that external air may flow in from one end of the liquid transfer unit 142 and flow out from an other end of the liquid transfer unit 142.

It should be noted that, in another example, it is also feasible that the spacer 142a is not arranged. In this case, a cross-section of the liquid transfer unit 142 is in a shape of a circular ring. End portions on two ends (in a transverse direction) of the susceptor 141 may be embedded or buried in the liquid transfer unit 142. In other words, a transverse size of the susceptor 141 is greater than an inner diameter of the liquid transfer unit 142 and less than an outer diameter of the liquid transfer unit 142. It should be noted that, in this example, the susceptor 141 may be made of a material that can guide liquid and generate heat in the variable magnetic field.

It should be noted that, in another example, it is also feasible that the second chamber 142c is not arranged or only the first chamber 142b is arranged. However, correspondingly, the liquid transfer unit 142 has a relatively large volume.

It should be noted that, in another example, it is also feasible that the susceptor 141 may be further completely buried in the spacer 142a (in this case, the susceptor 141 may also be regarded as being arranged within the liquid transfer unit 142) due to a relatively small thickness size of the susceptor 141. In this case, the cross-sectional area of the first chamber 142b may be the same as the cross-sectional area of the second chamber 142c.

It should be noted that, in another example, at least part of the spacer 142a may also be formed by the susceptor 141. The hollow interior of the liquid transfer unit 142 is divided into the first chambers 142b and the second chamber 142c by the susceptor 141. In this case, the cross-sectional area of the first chamber 142b may also be the same as the cross-sectional area of the second chamber 142c.

The bottom base 16 includes the first portion 161 and the second portion 162 that are integrally formed. In another example, it is also feasible that the first portion 161 and the second portion 162 are separately formed.

The first portion 161 is substantially in a shape of an ellipse and is accommodated in the upper shell 11. An area of an upper open end of the first portion 161 is greater than an area of a lower open end thereof, and the lower open end is close to the second portion 162 or defines an upper open end of the second portion 162. In the first portion 161, the upper open end and the lower open end are connected by at least one inner inclined surface 161c, so that an interior thereof is funnel-shaped, and then the liquid substrate can flow to the second portion 162 without accumulating in the first portion 161.

In a preferred implementation, an outer surface of the first portion 161 is provided with a bump (not shown), and an inner surface of the upper shell 11 is provided with a groove (not shown). A snap fit of the first portion 161 and the upper shell 11 is implemented through engagement of the bump and the groove.

In a preferred implementation, a lower end of the first portion 161 has a support portion 161a extending radially outward, to support an end portion of a lower end of the upper shell 11. The outer surface of the first portion 161 close to the upper end is further provided with a step. A part of the seal member 12 is held on the step.

The second portion 162 is exposed from the upper shell 11 or the atomizer 10. A thickness size of the second portion 162 is less than a size of the first portion 161 in a thickness direction, and a width size of the second portion 162 is less than a size of the first portion 161 in a width direction (or the cross-sectional area of the first portion 161 is greater than the cross-sectional area of the second portion 162). However, a size of the second portion 162 in a length (or longitudinal) direction is greater than a size of the first portion 161 in the length direction.

In a preferred implementation, the cross section of the second portion 162 is in a shape of an ellipse. A length of a major axis d1 of the ellipse is in a range of 8 mm to 9 mm (preferably in a range of 8 mm to 8.8 mm, further preferably in a range of 8 mm to 8.6 mm, further preferably in a range of 8.2 mm to 8.6 mm, and further preferably in a range of 8.4 mm to 8.6 mm). A length of a minor axis d2 of the ellipse is in a range of 6 mm to 8 mm (preferably in a range of 7 mm to 8 mm, further preferably in a range of 7.2 mm to 8 mm, further preferably in a range of 7.4 mm to 8 mm, further preferably in a range of 7.6 mm to 8 mm, and further preferably in a range of 7.6 mm to 7.8 mm). In a specific embodiment, the length of the major axis d1 is 8.5 mm, and the length of the minor axis d2 is 7.7 mm.

An air inlet 162a is provided on a bottom end of the second portion 162. A wall on which the air inlet 162a is formed protrudes from the bottom end of the second portion 162, to prevent the liquid substrate collected in the collecting cavity 162c from directly flowing to the power supply assembly 20 through the air inlet 162a. External air flows in through the air inlet 162a, successively passes through the liquid transfer unit 142 having a tubular structure (and/or the susceptor 141), the upper support 13, and the transmission tube 11a, and flows out of an air outlet of the upper shell 11, thereby defining or forming the airflow channel of the electronic atomization apparatus 100.

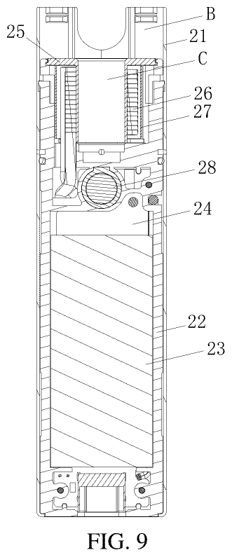

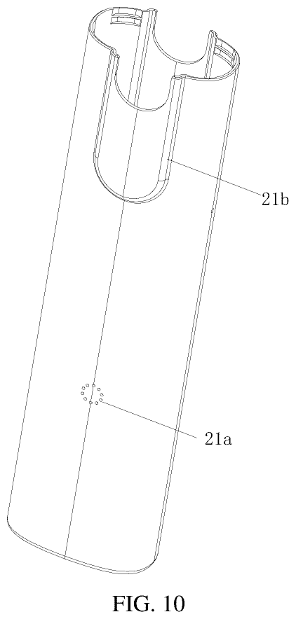

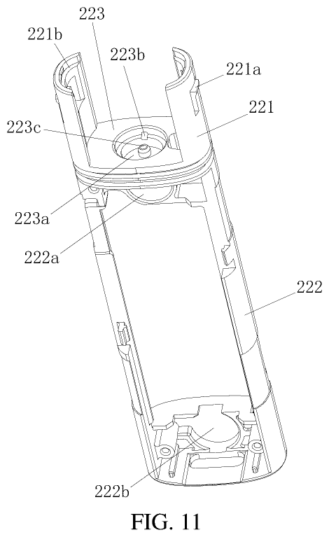

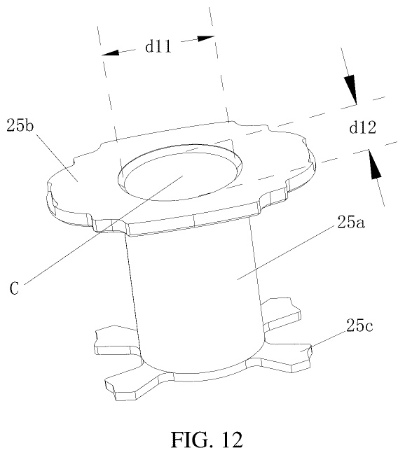

As shown in FIG. 9 to FIG. 14, the power supply assembly 20 includes a lower shell 21, a lower support 22, a battery core 23, a circuit 24, a base 25, a magnetic field generator 26, a shielding member 27, and a sensor 28.

The lower shell 21 is a cylindrical structure having two open ends. The lower shell 21 and the upper shell 11 define or form a housing of an electronic atomization apparatus 100.

An airflow inlet 21a is provided on an outer surface of the lower shell 21. External air may flow into the lower shell 21 through the airflow inlet 21a. Front and rear parts of the lower shell 21 protrude to form a protruding portion 21b. Through the protruding portion 21b, a size of a part of the electronic atomization apparatus 100 in a thickness direction may be increased, and then a magnetic field generator 26 with a larger size may be accommodated, for example, an induction coil.

The lower support 22 includes an accommodating portion 221 and a mounting portion 222. The accommodating portion 221 and the mounting portion 222 are separated by a separating plate 223.

The lower support 22 is accommodated in the lower shell 21. A size of the lower support 22 in a length direction is less than a size of the lower shell 21 in a length direction. A receiving portion B is formed between an upper end of the lower support 22 and an upper end of the lower shell 21. A lower end of the lower support 22 abuts against an end portion of a lower end of the lower shell 21. After assembly, a part of the upper shell 11 is received in the receiving portion B.

An outer surface of the accommodating portion 221 is provided with a cantilever 221a. The cantilever 221a is snap-fitted to a groove on the inner surface of the lower shell 21. An inner surface of the accommodating portion 221 is provided with a step 221b. A body portion 25a of the base 25 is accommodated in the accommodating portion 221. An extension 25b of the base 25 abuts against the step 221b, and a plurality of extensions 25c of the base 25 abut against the separating plate 223.

A component may be mounted to the front and rear of the mounting portion 222. In the example, the battery core 23 is mounted to the front of the mounting portion 222, and the circuit 24 is mounted to the rear of the mounting portion 222. To be specific, the components are successively arranged along the thickness direction of the electronic atomization apparatus 100. An accommodating chamber 222a and an accommodating chamber 222b are further arranged in the mounting portion 222. The accommodating chamber 222a is configured to accommodate the sensor 28. The accommodating chamber 222b is configured to accommodate a motor (not shown). The motor generates a prompt signal to prompt a user. Specific prompt information is not limited herein.

A groove 223a is provided on the separating plate 223. The groove 223a is coaxial with a receiving portion C. An airflow inlet 223b is provided in the groove 223a. Air may flow into the groove 223a through the airflow inlet 223b, and then flow into an atomizer 10 through the air inlet 162a of a bottom base 16. An induction channel 223c is further provided in the groove 223a. The induction channel 223c is in communication with the accommodating chamber 222a.

The battery core 23 is configured to provide electric power for operating the electronic atomization apparatus 100. The battery core 23 may be a rechargeable battery core or a disposable battery core.

The circuit 24 may control overall operations of the electronic atomization apparatus 100. The circuit 24 not only controls operations of the battery core 23 and the magnetic field generator 26, but also controls an operation of another element in the electronic atomization apparatus 100. The circuit 24 includes at least one processor. The processor may include a logic gate array, or may include a combination of a general-purpose microprocessor and a memory that stores programs executable in the microprocessor. In addition, a person skilled in the art should understand that the circuit 24 may include another type of hardware.

The base 25 includes the body portion 25a, and an internal hollow portion thereof defines or forms at least part of the receiving portion C. An upper end of the body portion 25a is provided with the extension 25b, and the lower end thereof is provided with a plurality of extensions 25c. After assembly, at least part of the second portion 162 of the bottom base 16 is received in the receiving portion C. Sizes of the receiving portion C in a direction perpendicular to the longitudinal direction (the transverse direction and the thickness direction) of the electronic atomization apparatus 100 are both in a range of 7 mm to 20 mm.

In a preferred implementation, a cross section of the body portion 25a is in the shape of an ellipse. In other words, the receiving portion C is in the shape of an ellipse, and a difference between a major axis and a minor axis of the receiving portion C is in a range of 0.5 mm to 2 mm. The receiving portion C is in the shape of an ellipse, which is beneficial to the overall flat shape of the electronic atomization apparatus 100, thereby improving aesthetics of the electronic atomization apparatus 100. Specifically, a length of a major axis d11 of the ellipse is in a range of 7 mm to 10 mm (preferably in a range of 7 mm to 9 mm, further preferably in a range of 7.5 mm to 9 mm, further preferably in a range of 8 mm to 9 mm, and further preferably in a range of 8.5 mm to 9 mm). A length of a minor axis d12 of the ellipse is in a range of 7 mm to 9 mm (preferably in a range of 7 mm to 8.5 mm, further preferably in a range of 7 mm to 8.3 mm, further preferably in a range of 7 mm to 8.1 mm, further preferably in a range of 7.5 mm to 8.1 mm, further preferably in a range of 7.7 mm to 8.1 mm, and further preferably in a range of 7.9 mm to 8.1 mm). In a specific embodiment, the length of the major axis d11 is 8.8 mm, and the length of the minor axis d12 is 8 mm.

The magnetic field generator 26 is configured to generate a variable magnetic field under an alternating current. The magnetic field generator 26 includes, but is not limited to, an induction coil. The magnetic field generator 26 is arranged close to the receiving portion C. The magnetic field generator 26 at least partially surrounds the receiving portion C. The body portion 26a of the magnetic field generator 26 is sleeved outside the body portion 25a of the base 25. An electrical connection portion 26b and an electrical connection portion 26c of the magnetic field generator 26 are configured to be electrically connected to the battery core 23. When the second portion 162 of the bottom base 16 is at least partially received in the receiving portion C, the atomization core 14 or the susceptor 141 is completely located in the receiving portion C, so that a magnetic field generated by the magnetic field generator 26 can substantially cover the susceptor 141. In this way, a coupling distance between the susceptor 141 and the magnetic field generator 26 is reduced, and heating efficiency of the atomizer 10 can be improved. In a preferred implementation, when the second portion 162 of the bottom base 16 is at least partially received in the receiving portion C, the susceptor 141 and the magnetic field generator 26 are coaxial and both extend along an axial direction of the electronic atomization apparatus 100. An extension length of the magnetic field generator 26 along the axial direction is greater than an extension length of the susceptor 141 along the axial direction.

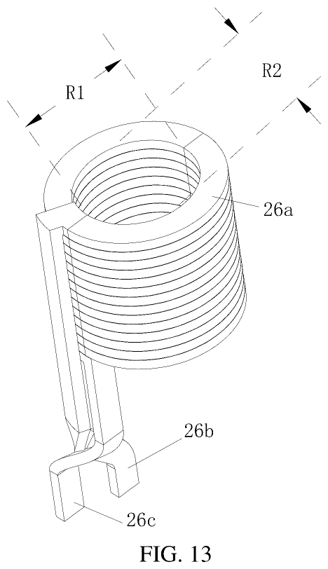

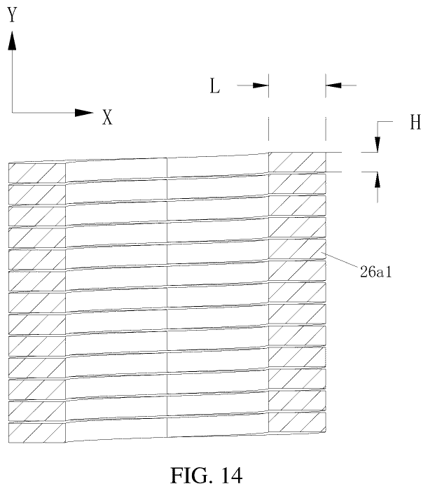

As shown in FIG. 13 and FIG. 14, the body portion 26a of the magnetic field generator 26 is a solenoid coil wound by a relatively long wire material. For example, 1600-1900 0.02 mm Litz wires are used for winding and molding, or 750-1050 0.03 mm Litz wires may also be used for winding and molding. A number of turns or windings of the solenoid coil is in a range of 6 to 20, preferably in a range of 6 to 15, further preferably in a range of 6 to 12, and further preferably in a range of 6 to 10. A spacing between adjacent windings is approximately in a range of 0.1-0.5 mm. The spacing between adjacent windings may be the same or different.

A cross section of a wire material has a first side extending along a radial direction X of the magnetic field generator 26 and a second side extending along an axial direction Y of the magnetic field generator 26. The cross section of the wire material is substantially in the shape of a rectangle. A size L of the first side is greater than a size H of the second side, so that the wire material of the magnetic field generator 26 has a flat structure, which is beneficial to increase the number of turns of the magnetic field generator 26 per unit length and then increase an inductance value. In addition, the second side is arranged against a wall of the receiving portion C, that is, arranged against the outer surface of the body portion 25a of the base 25. Alternatively, the number of turns of the magnetic field generator 26 may be increased within a limited height space.

In a preferred implementation, a ratio of the size L of the first side to the size H of the second side is in a range of 1.5-3, preferably in a range of 2-3, and further preferably in a range of 2.5-3. For example, in a specific embodiment, the ratio of the size L of the first side to the size H of the second side is 2.8.

In a preferred implementation, the size L of the first side is approximately in a range of 1-5 mm, and the size H of the second side is approximately in a range of 0.3-1 mm. For example, in a specific embodiment, the size L of the first side is 2.5 mm, and the size H of the second side is 0.9 mm.

In a preferred implementation, a total length of the body portion 26a of the magnetic field generator 26 along the axial direction Y is approximately in a range of 5-20 mm. In a specific embodiment, a total length of the body portion 26a of the magnetic field generator 26 along the axial direction Y is 12.2 mm.

In a preferred implementation, a hollow portion of the body portion 26a is in a shape of an ellipse, and a difference between a major axis and a minor axis of the ellipse is in a range of 0.5 mm to 2 mm. Specifically, a length of a major axis R1 of the ellipse is in a range of 8 mm to 15 mm (preferably in a range of 8 mm to 12 mm, further preferably in a range of 8 mm to 10 mm, and further preferably in a range of 9 mm to 10 mm). A length of a minor axis R2 of the ellipse is in a range of 8 mm to 13 mm (preferably in a range of 8 mm to 11 mm, further preferably in a range of 8 mm to 10 mm, and further preferably in a range of 8 mm to 9 mm). In a specific embodiment, the length of the major axis R1 of the ellipse is 9.7 mm, and the length of the minor axis R2 of the ellipse is 8.9 mm.

The shielding member 27 is sleeved outside the body portion 26a of the magnetic field generator 26. The shielding member 27 is configured to shield the magnetic field emitted from the magnetic field generator 26 substantially along the radial direction, to prevent the emitted magnetic field from affecting another component.

The sensor 28 is configured to sense a change in airflow in the groove 223a through the induction channel 223c, that is, detect inhalation of the user, to generate a signal to control the atomizer 10 to start operating.

It should be noted that the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are provided for the purpose of providing a more thorough and comprehensive understanding of the content disclosed in this application. In addition, the foregoing technical features are further combined with each other to form various embodiments not listed above, which are all deemed to be within the scope of the description of this application. Further, a person of ordinary skill in the art may make improvements or modifications according to the above descriptions, and all of the improvements and modifications shall fall within the protection scope of the appended claims of this application.

1. An atomization core comprising:
a liquid transfer unit, constructed in a shape of a tube with a hollow interior, wherein an outer surface of the liquid transfer unit is configured to absorb a liquid substrate; and
a susceptor, configured to be penetrated by a variable magnetic field to generate heat, so as to heat the liquid substrate absorbed by the liquid transfer unit to generate an aerosol, wherein the susceptor is constructed to be shaped like a plate or a sheet;
wherein the susceptor is arranged within the liquid transfer unit, and at least part of a surface of the susceptor is in contact with the liquid transfer unit.

2. The atomization core according to claim 1, wherein a transverse size of the susceptor is the same as an inner diameter of the liquid transfer unit, or a transverse size of the susceptor is greater than an inner diameter of the liquid transfer unit and less than an outer diameter of the liquid transfer unit.

3. The atomization core according to claim 1, wherein a longitudinal size of the susceptor is the same as a longitudinal size of the liquid transfer unit.

4. The atomization core according to claim 1, wherein a longitudinal size of the susceptor is greater than a transverse size of the susceptor.

5. The atomization core according to claim 1, wherein a longitudinal extension direction of the susceptor is parallel to or coincides with a central axis of the liquid transfer unit.

6. The atomization core according to claim 1, further comprising a spacer, wherein the spacer is configured to divide the hollow interior of the liquid transfer unit into a first chamber and a second chamber.

7. The atomization core according to claim 6, wherein:
a cross-sectional area of the first chamber is greater than a cross-sectional area of the second chamber; and
the susceptor is arranged within the first chamber, and the susceptor maintains contact with a side wall of the spacer or is partially buried in the spacer.

8. The atomization core according to claim 6, wherein the cross-sectional area of the first chamber is the same as the cross-sectional area of the second chamber, and the susceptor is completely buried in the spacer or the susceptor defines the spacer.

9. The atomization core according to claim 6, wherein a thickness size of the susceptor is less than a thickness size of the spacer.

10. The atomization core according to claim 1, wherein the hollow interior of the liquid transfer unit forms an airflow channel, so that external air flows in from one end of the liquid transfer unit and flows out from another end of the liquid transfer unit.

11. The atomization core according to claim 1, wherein the susceptor has a plurality of through holes arranged at intervals along a thickness direction.

12. An atomizer configured for an electronic atomization apparatus, comprising:
a liquid storage chamber for storing a liquid substrate; and
the atomization core according to claim 1.

13. An electronic atomization apparatus comprising:
a magnetic field generator configured to generate a variable magnetic field under an alternating current; and
the atomization core according to claim 1.
